(19) United States
(12) Patent Application Publication
(10) Pub. No.: US 2022/0149778 A1
(43) Pub. Date: May 12, 2022

(54) MODULAR HARDENED SOLAR ELECTRONICS PLATFORM

(71) Applicant: ArmorForge, LLC, Punta Gorda, FL (US)

(72) Inventor: Dan Pearson, Punta Gorda, FL (US)

(21) Appl. No.: 17/521,566

(22) Filed: Nov. 8, 2021

Related U.S. Application Data
(60) Provisional application No. 63/110,882, filed on Nov. 6, 2020.

(51) Int. Cl. H02S 30/20; H02S 20/10

(52) U.S. Cl. CPC H02S 30/20; H02S 20/10

(57) ABSTRACT

A solar electronics platform includes a base, which comprises a plurality of base modules. The solar electronics platform also includes a body that is movably coupled to the base such that the body is pivotable, relative to the base, between a vertical orientation and a horizontal orientation, inclusive. The body includes a head portion, having one or more security modules, and a mast carrier, configured to raise and lower the head portion relative to the base when the body is in the vertical orientation. The solar electronics platform further comprises a solar panel system that is movably coupled to the base such that the solar panel system is pivotable, relative to the base, about at least one base axis of rotation.

### CROSS-REFERENCE TO RELATED APPLICATION

This application claims the benefit of U.S. Provisional Patent Application No. 63/110,882, filed Nov. 6, 2020, which is incorporated herein by reference.

### FIELD

The present disclosure relates generally to a modular electronics platform, and more particularly to a solar-powered modular electronics platform for providing surveillance, security, and/or other functionality.

### BACKGROUND

Transportable surveillance systems are used to provide security surveillance at various temporary use locations, such as construction sites, storage sites, personnel housing and training sites, and the like. Some conventional surveillance systems include surveillance trailers, with solar panels and/or generators, that can be driven to and parked at a surveillance location. However, such surveillance trailers fail to provide adequate protection against destruction to the trailers (e.g., assailants stripping the surveillance trailer for parts) when the trailers are permanently deployed or left in unsupervised environments. Other conventional surveillance systems include tall hydraulic towers or permanently fixed poles with surveillance equipment and/or solar panels. However, such systems are difficult and expensive to install (e.g., by requiring digging, trenching, heavy installation equipment, etc.), require construction permits, require heavy equipment to service, and do not provide adequate protection against destruction. Additionally, many conventional surveillance systems are unable to provide adequate electrical power for some surveillance and communication equipment and fail to provide sufficient portability, modularity, and environmental protections for some applications.

### SUMMARY

The subject matter of the present application has been developed in response to the present state of the art, and in particular, in response to the problems and needs of conventional systems, devices, and methods for providing deployment of, power to, and protection of outdoor electronic surveillance equipment in a transportable package that have not yet been fully solved. In view of the foregoing, the subject matter of the present application has been developed to provide a solar electronics platform for providing deployment of, power to, and protection of outdoor electronic surveillance equipment in a transportable package that overcome many of the shortcomings of the prior art.

The following is a non-exhaustive list of examples, which may or may not be claimed, of the subject matter, disclosed herein.

Disclosed herein is a solar electronics platform that comprises a base, which comprises a plurality of base modules. The solar electronics platform also comprises a body that is movably coupled to the base such that the body is pivotable, relative to the base, between a vertical orientation and a horizontal orientation, inclusive. The body also comprises a head portion, having one or more security modules, and a mast carrier, configured to raise and lower the head portion relative to the base when the body is in the vertical orientation. The solar electronics platform further comprises a solar panel system that is movably coupled to the base such that the solar panel system is pivotable, relative to the base, about at least one base axis of rotation. The preceding subject matter of this paragraph characterizes example 1 of the present disclosure.

The solar panel system is pivotable, relative to the base, about at least two base axes of rotation. The preceding subject matter of this paragraph characterizes example 2 of the present disclosure, wherein example 2 also includes the subject matter according to example 1, above.

The at least two base axes of rotation are perpendicular relative to each other. The preceding subject matter of this paragraph characterizes example 3 of the present disclosure, wherein example 3 also includes the subject matter according to example 2, above.

When the base is supported on a ground surface, one of the at least two base axes of rotation is perpendicular to the ground surface and another one of the at least two base axes of rotation is parallel to the ground surface. The preceding subject matter of this paragraph characterizes example 4 of the present disclosure, wherein example 4 also includes the subject matter according to any one of examples 2-3, above.

The solar panel system comprises a solar-panel assembly that comprises a first solar panel and a second solar panel pivotably coupled together along a hinge. The preceding subject matter of this paragraph characterizes example 5 of the present disclosure, wherein example 5 also includes the subject matter according to any one of examples 1-4, above.

The first solar panel and the second solar panel are pivotable relative to each other about the hinge between a folded configuration, in which the first solar panel and the second solar panel are parallel to each other and laid flat against each other, and an unfolded configuration, in which the first solar panel and the second solar panel are side-by-side and co-planar. The preceding subject matter of this paragraph characterizes example 6 of the present disclosure, wherein example 6 also includes the subject matter according to example 5, above.

The hinge defines two panel axes of rotation. The first solar panel and the second solar panel are pivotable about the two panel axes of rotation. The two panel axes of rotation are parallel and spaced apart from each other. The preceding subject matter of this paragraph characterizes example 7 of the present disclosure, wherein example 7 also includes the subject matter according to example 6, above.

The two panel axes of rotation are either parallel to or perpendicular to the at least one base axes of rotation. The preceding subject matter of this paragraph characterizes example 8 of the present disclosure, wherein example 8 also includes the subject matter according to example 7, above.

The solar panel system comprises two solar-panel assemblies each coupled to a corresponding one of two opposite sides of the base. The preceding subject matter of this paragraph characterizes example 9 of the present disclosure, wherein example 9 also includes the subject matter according to any one of examples 6-8, above.

The two solar-panel assemblies are spaced apart from each other, such that a gap is defined between the two solar-panel assemblies. At least a portion of the body is located in the gap when the body is in the horizontal orientation. The preceding subject matter of this paragraph characterizes example 10 of the present disclosure, wherein example 10 also includes the subject matter according to example 9, above.

The solar panel system is pivotable, relative to the base, about at least two base axes of rotation. The two solar-panel assemblies are co-planar or parallel to each other as the solar panel system pivots about a first one of the at least two base axes of rotation. The two solar-panel assemblies transition from being co-planar or parallel to each other to being angled relative to each other as the solar panel system pivots about second ones of the at least two base axes of rotation. The preceding subject matter of this paragraph characterizes example 11 of the present disclosure, wherein example 11 also includes the subject matter according to any one of examples 9-10, above.

The solar-panel assembly further comprises a gasket fixed to at least one of the first solar panel and the second solar panel. When in the folded configuration, the gasket forms a seal between the first solar panel and the second solar panel. The preceding subject matter of this paragraph characterizes example 12 of the present disclosure, wherein example 12 also includes the subject matter according to any one of examples 6-11, above.

The solar panel system comprises a solar-panel assembly comprising a solar panel. When the base is supported on a ground surface, the solar panel system is pivotable about the at least one base axis of rotation between a first orientation, in which the solar panel is parallel to the ground surface, a second orientation, in which the solar panel defines an acute angle relative to the ground surface, and a third orientation, in which the solar panel is perpendicular to the ground surface. The preceding subject matter of this paragraph characterizes example 13 of the present disclosure, wherein example 13 also includes the subject matter according to any one of examples 1-12, above.

When in the first orientation, an entirety of the solar panel is above the base, such that an entirety of the base is between the solar panel and the ground surface. When in the third orientation, at least a portion of the solar panel is below the base, such that at least the portion of the solar panel is closer to the ground surface than a top of the base. The preceding subject matter of this paragraph characterizes example 14 of the present disclosure, wherein example 14 also includes the subject matter according to example 13, above.

The base further comprises a plurality of legs that are extendable and retractable relative to the plurality of base modules. The preceding subject matter of this paragraph characterizes example 15 of the present disclosure, wherein example 15 also includes the subject matter according to any one of examples 1-14, above.

At least one of the plurality of base modules contains at least one battery that is electrically coupled with the solar panel system to receive electrical power from the solar panel system and electrically coupled with the head portion to provide power to the one or more security modules. The preceding subject matter of this paragraph characterizes example 16 of the present disclosure, wherein example 16 also includes the subject matter according to any one of examples 1-15, above.

The solar panel system is pivotable, relative to the base, about at least three base axes of rotation. The preceding subject matter of this paragraph characterizes example 17 of the present disclosure, wherein example 17 also includes the subject matter according to any one of examples 1-16, above.

The mast carrier comprises a base-extension portion and a mast-containment portion. The mast-containment portion contains a mast of the body that supports the head portion and that is raisable and lowerable within the mast-containment portion. The base-extension portion is angled relative to the mast-containment portion. The base-extension portion is pivotably coupled directly to the base and is located between the mast-containment portion and the base. The preceding subject matter of this paragraph characterizes example 18 of the present disclosure, wherein example 18 also includes the subject matter according to any one of examples 1-17, above.

The solar panel system comprises a first solar panel fixed to the head portion at a first angle relative to a horizontal plane and a second solar panel fixed to the body at a second angle relative to the horizontal plane. The first angle is less than the second angle. The preceding subject matter of this paragraph characterizes example 19 of the present disclosure, wherein example 19 also includes the subject matter according to any one of examples 1-18, above.

Adjacent ones of the plurality of base modules are interlocked together via alignment between sockets of the adjacent ones of the plurality of base modules and locking sleeves engaged with the sockets. The preceding subject matter of this paragraph characterizes example 20 of the present disclosure, wherein example 20 also includes the subject matter according to any one of examples 1-19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended numbered paragraphs or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic, perspective view of a solar electronics platform, according to one or more examples of the present disclosure;

FIG. 2 is a schematic, perspective view of the solar electronics platform of FIG. 1, according to one or more examples of the present disclosure;

FIG. 3 is a schematic, perspective view of the solar electronics platform of FIG. 1, shown with a body of the platform in a tilted configuration, according to one or more examples of the present disclosure;

FIG. 4 is a schematic, top plan view of a base module of a solar electronics platform, according to one or more examples of the present disclosure;

FIG. 5A is a schematic, top plan view of a module tree of a solar electronics platform, according to one or more examples of the present disclosure;

FIG. 5B is a schematic, top plan view of a module tree of a solar electronics platform, according to one or more examples of the present disclosure;

FIG. 6 is a schematic, top plan view of a module formation of a solar electronics platform, according to one or more examples of the present disclosure;

FIG. 7 is a schematic, top plan view of a module formation of a solar electronics platform, according to one or more examples of the present disclosure;

FIG. 8 is a schematic, top plan view of a module formation of a solar electronics platform, according to one or more examples of the present disclosure;

FIG. 9A is a schematic, sectional, front elevation view of a mast carrier of a solar electronics platform, according to one or more examples of the present disclosure;

FIG. 9B is a schematic, sectional, side elevation view of a mast carrier of a solar electronics platform, according to one or more examples of the present disclosure;

FIG. 10 is a schematic, side elevation view of a body of a solar electronics platform, according to one or more examples of the present disclosure;

FIG. 11 is a schematic, side elevation view of a canopy of a solar electronics platform, according to one or more examples of the present disclosure;

FIG. 12 is a schematic, perspective view of a solar electronics platform, shown in a first configuration, according to one or more examples of the present disclosure;

FIG. 13 is a schematic, front elevation view of the solar electronics platform of FIG. 12, according to one or more examples of the present disclosure;

FIG. 14 is a schematic, back elevation view of the solar electronics platform of FIG. 12, according to one or more examples of the present disclosure;

FIG. 15 is a schematic, side elevation view of the solar electronics platform of FIG. 12, according to one or more examples of the present disclosure;

FIG. 16 is a schematic, perspective view of the solar electronics platform of FIG. 12, shown in the first configuration, according to one or more examples of the present disclosure;

FIG. 17 is a schematic, perspective view of the solar electronics platform of FIG. 16, according to one or more examples of the present disclosure;

FIG. 18 is a schematic, side elevation view of the solar electronics platform of FIG. 16, according to one or more examples of the present disclosure;

FIG. 19 is a schematic, perspective view of the solar electronics platform of FIG. 12, shown in a second configuration, according to one or more examples of the present disclosure;

FIG. 20 is a schematic, perspective view of the solar electronics platform of FIG. 19, according to one or more examples of the present disclosure;

FIG. 21 is a schematic, perspective view of a panel folding system, shown with panels in a folded configuration, according to one or more examples of the present disclosure;

FIG. 22 is a schematic, perspective view of the panel folding system of FIG. 21, shown with panels in an unfolded configuration, according to one or more examples of the present disclosure;

FIG. 23 is a schematic, perspective view of the solar electronics platform of FIG. 12, shown in a third configuration, according to one or more examples of the present disclosure;

FIG. 24 is a schematic, front elevation view of the solar electronics platform of FIG. 12, shown in the third configuration, according to one or more examples of the present disclosure;

FIG. 25 is a schematic, front elevation view of the solar electronics platform of FIG. 12, shown in the third configuration, according to one or more examples of the present disclosure;

FIG. 26 is a schematic, perspective view of a base module of the solar electronics platform of FIG. 12, according to one or more examples of the present disclosure; and

FIG. 27 is a schematic, perspective view of a housing of a base of the solar electronics platform of FIG. 12, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

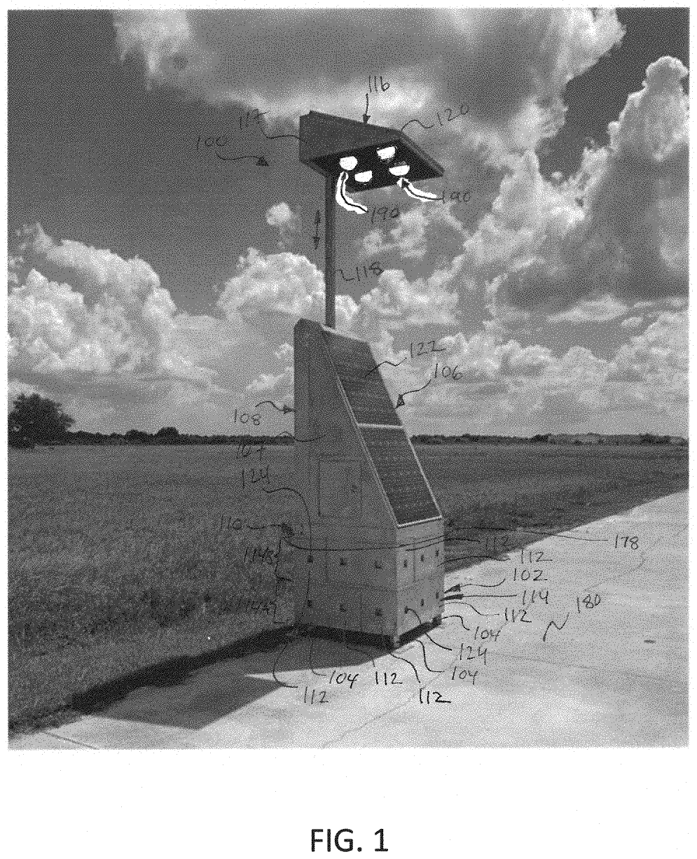

Referring to FIG. 1, and according to some examples of the present disclosure, a solar electronics platform 100 includes a base 102 and a body 106. The body 106 is supported directly or indirectly on the base 102 and extends vertically above the base 102 in an operational position, as shown in FIG. 1. The base 102 includes a plurality of base modules 112 that are intercoupled (e.g., interlocked) and arranged into a module formation 114. Each one of the base modules 112 includes a plurality of sockets 124. The plurality of sockets 124 of each one of the base modules 112 facilitates a secure intercoupling of each one of the base modules 112 with a corresponding two other ones of the module formation 114. The base 102 further includes a plurality of legs 104 that support the module formation 114 of the base 102 on a support surface, such as a ground surface 180. The plurality of legs 104 are extendable and retractable, relative to the module formation 114, to adjust a position or orientation of the module formation 114, and thus the body 106 supported on the base 102, relative to the ground surface 180. Accordingly, the plurality of legs 104 can be operable to level the module formation 114 and the body 106 on an otherwise non-level ground surface. Additionally, the plurality of legs 104 can be operable to raise the base 102 for attachment of wheels or axels to the base 102.

In the present example shown in FIG. 1, the module formation 114 includes a first layer 114A of intercoupled base modules 112 and a second layer 114B of intercoupled base modules 112. The second layer 114B is stacked on and intercoupled with the first layer 114A via a plurality of sockets, similar to the plurality of sockets 124. Accordingly, each one of the base modules 112 includes a plurality of sockets 124 formed in sides of the base modules 112 that facilitates the lateral intercoupling of base modules 112 into a layer (e.g., the first layer 114A or the second layer 114B) of the module formation 114. As described in more detail below, the module formation 114 can include any number of layers of base modules 112 and any number of base modules 112 per layer. In this manner, the solar electronics platform 100 is highly modular and customizable without diminishing the portability of the solar electronics platform 100.

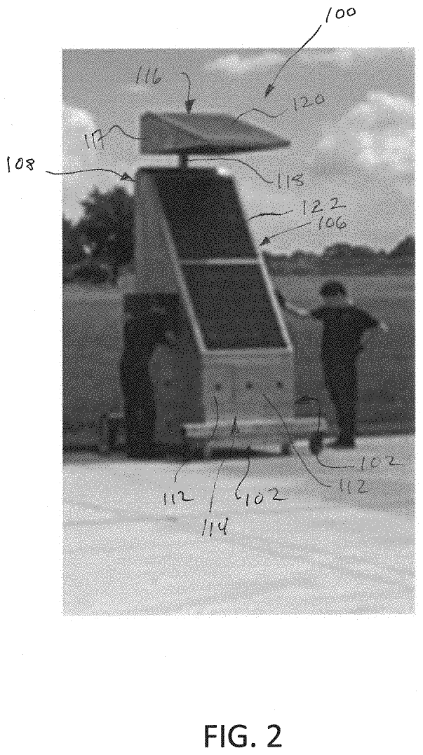

The body 106 includes a mast carrier 108 and a canopy 116 (or head portion) that is movably coupled with the mast carrier 108. The canopy 116 is movably coupled with the mast carrier 108 via a neck 118 or mast that retracts into and extends out from the mast carrier 108. Accordingly, the canopy 116 is raisable above the mast carrier 108 into a raised position (see, e.g., FIG. 1) and lowerable towards the mast carrier 108 into a lowered position (see, e.g., FIG. 2). The canopy 116 includes one or more security modules 190 coupled to an underside of a housing 117 of the canopy 116. However, in other examples, the security modules 190 can be coupled to any of various other portions of the housing 117. Each one of the security modules 190 includes electronic components (e.g., cameras, sensors, lights, transceivers, antennas, etc.) configured to provide one or more security operations, such as video surveillance, infrared surveillance (e.g., thermal and/or night-vision), motion detection, auditory or visual warnings/alarms, wireless communications, lighting, and the like. In certain examples, the security modules 190 can be retractable to facilitate retraction of the security modules 190 up into the housing 117 of the canopy 116.

The solar electronics platform 100 further includes solar panels to provide a renewable energy source for powering the electronic components (e.g., the security modules 190) of the solar electronics platform 100. For example, in the illustrated implementation of FIG. 1, the solar electronics platform 100 includes a first solar panel 120 and a second solar panel 122. Each one of the first solar panel 120 and the second solar panel 122 is configured to convert solar energy from the sun to electrical energy. The electrical energy produced by the first solar panel 120 and the second solar panel 122 can be stored in batteries housed within one or more of the base modules 112. The first solar panel 120 forms part of the canopy 116. More specifically, the first solar panel 120 is fixed to an angled upper surface of the housing 117 of the canopy 116. The second solar panel 122 forms part of the body 106. More specifically, the second solar panel 122 is fixed to an angled surface of a housing 107 of the body 106.

In some examples, the body 106 is movably coupled to the base 102 by an articulation interface 110. In some examples, the articulation interface 110 facilitates movement of the body 106 relative to the base 102 with two degrees of freedom. In one example, as shown by directional arrows 178 the articulation interface 110 is swivelable relative to the base 102 along a plane parallel to the ground surface 180 (when the ground surface 180 is level). Swiveling of the articulation interface 110, and thus the body 106, relative to the base 102 can be enabled by a central pin non-movably fixed to one of the articulation interface 110 or the base 102 that is received in a correspondingly-sized aperture in the other of the articulation interface 110 or the base 102. Rollers can be incorporated to help facilitate low friction swiveling of the articulation interface 110 relative to the base 102. Additionally, swiveling of the articulation interface 110 relative to the base 102 can be automatically controlled and driven by a motor.

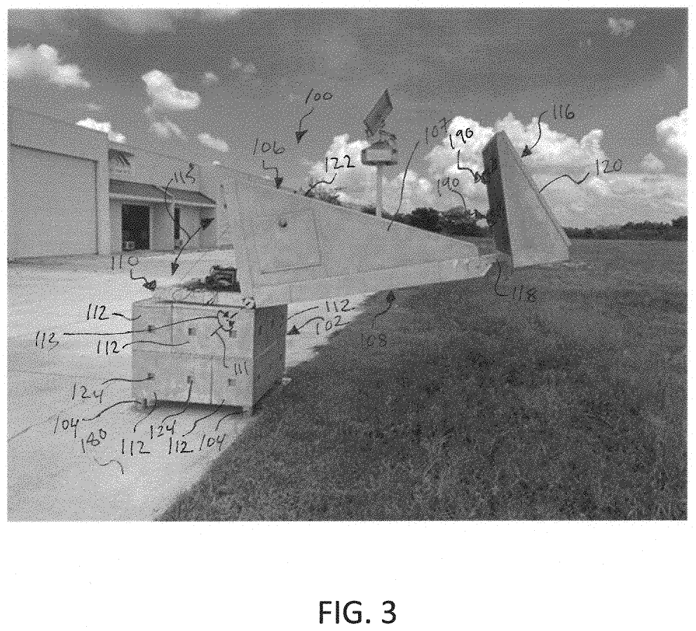

The articulation interface 110 also, or alternatively, facilitates tilting of the body 106 relative to the base 102. As shown in FIG. 3, the articulation interface 110 includes a pivot pin, defining a pivot axis 111, about which the body 106 is allowed to pivot. As used herein, a pivot axis can be defined as an axis of rotation. Accordingly, the body 106 can be tilted downwardly, as shown by directional arrows 115, about the pivot axis 111 or axis of rotation, as shown by directional arrows 113, to provide access to an interior of the housing 107 for repairs, replacements, modifications, or otherwise. The body 106 can then be tilted upwardly to close off access to the interior of the housing 107. However, in certain examples, the housing 107 may be closed on the bottom such that tilting the body 106 downwardly does not provide access to the interior of the housing 107. In some examples, the articulation interface 110 includes a motor and cabling to power and control the downwardly and upwardly tilting of the body 106. However, in other examples, other articulation devices, such as a hydraulic or pneumatic actuators, can be used. According to one application of the solar electronics platform 100, the pivoting action of the articulation interface 110 allows the body 106 to be rotated to provide space to tilt the body 106 when enough clearance to tilt the body 106 is not available without rotation of the body 106 (e.g., when the solar electronics platform 100 is backed against a wall or other structure).

Now referring to FIG. 4, in one example, each one of the base modules 112 of the module formation 114 includes a first side panel 130A and a second side panel 130B that is opposite the first side panel 130A. Additionally, the base module 112 includes a first end panel 132A (e.g., third side) and a second end panel 132B (e.g., fourth side) that is opposite the first end panel 132A. In the illustrated example, the first side panel 130A is parallel to the second side panel 130B and the first end panel 132A is parallel to the second end panel 132B. Accordingly, the first side panel 130A and the second side panel 130B are perpendicular to the first end panel 132A and the second end panel 132B. In some examples, the first side panel 130A and the second side panel 130B each has a length L and the first end panel 132A and the second end panel 132B each has a width W. The length L is longer than the width W in the illustrated examples. Therefore, in the illustrated example, the base modules 112 each has a rectangular shape in plan view, as shown in FIG. 4. The base module 112 also includes a bottom panel 131 and a top panel (not shown) that is opposite and parallel to the bottom panel 131. In certain examples, the top panel is a lid that is selectively attachable to (such as via a tamper-proof locking mechanism) and selectively removable from (such as via a key or other authorization mechanism) the side panels to enclose an interior space 126 of the base module 112. Accordingly, the panels of the base module 112 define and enclose an interior space 126 of the base module 112. After the interior space 126 is enclosed, access to the interior space 126 is disabled without proper authorization.

The interior space 126 of each one of the base modules 112 can contain any of various objects as desired. In one example, some of the base modules 112 contain a weighting or ballast material, such as sand, for anchoring the solar electronics platform 100 to a support surface. In the same or alternative examples, others of the base modules 112 contain one or more batteries, such as rechargeable batteries. The batteries can be recharged with power collected by the solar panels of the solar electronics platform 100. Any of various other electronic or non-electronic equipment can be stored in the interior spaces 126 of the base modules 112.

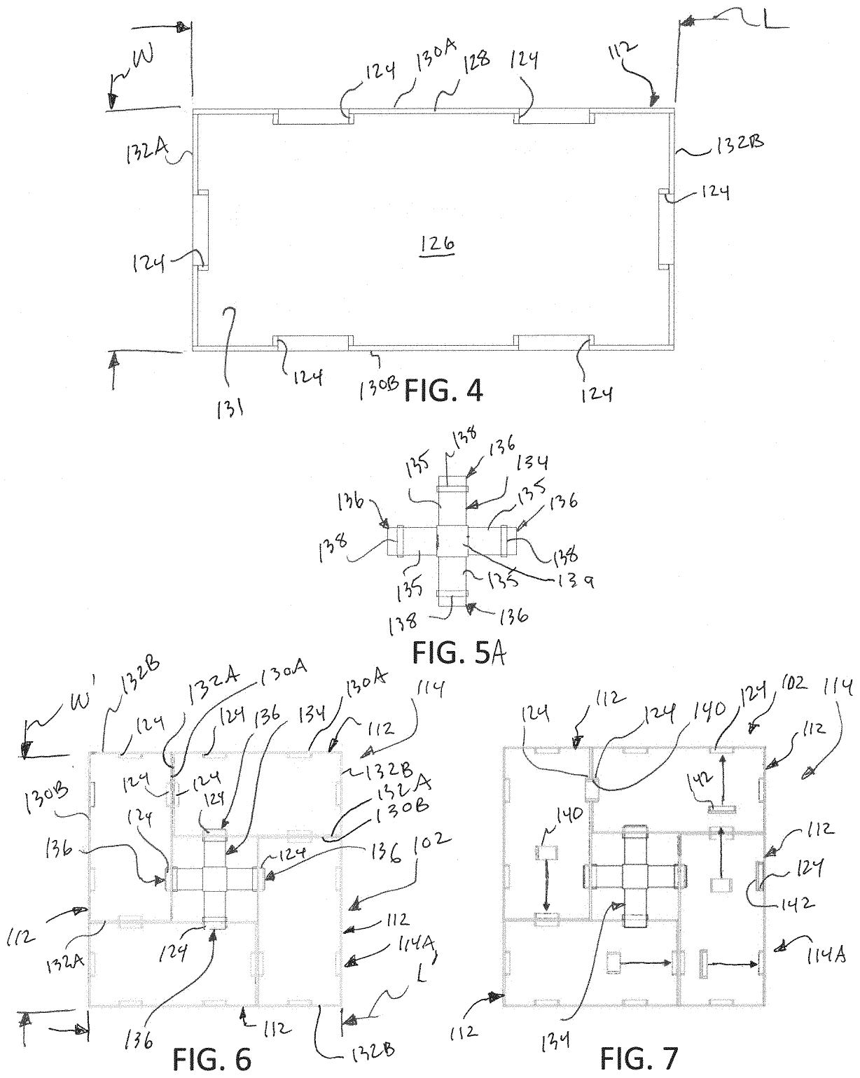

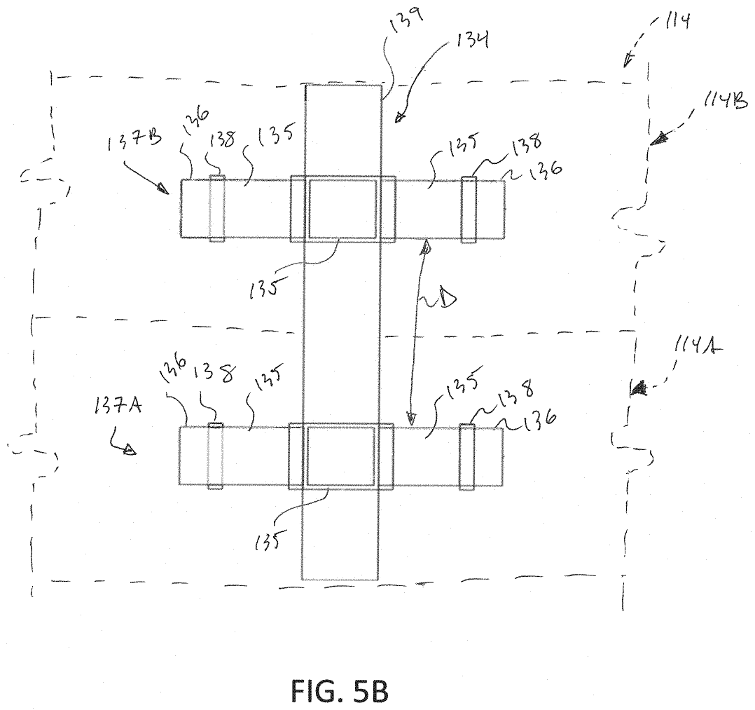

Referring to FIGS. 5A-7, the module formation 114 includes a module tree 134 at a center of the first layer 114A of intercoupled base modules 112. The module tree 134 is configured to ensure the first four base modules 112 of the first layer 114A are properly positioned relative to each other by locking the base modules 112 to the module tree 134. By ensuring proper positioning between the first base modules 112 of the first layer 114A, proper positioning of all other base modules 112 of the first layer 114A, relative to each other, is ensured via the intercoupling of the base modules 112. The module tree 134 is symmetrical and includes four legs 135 equally spaced apart and having the same length. Accordingly, each one of the legs 135 is 90-degrees away from any adjacent one of the legs 135. The legs 135 extend perpendicularly away from a central upright member 139 of the module tree 134. Each one of the legs 135 includes an end portion 136 and a stop 138 spaced apart from the end portion 136. The end portion 136 is configured to fit into (up to the stop 138) and securely engage, via a locking sleeve 140 (see below), a corresponding one of the sockets 124 of a corresponding one of the first four base modules 112 of the first layer 114A. As shown in FIG. 6, with the first four base modules 112 arranged end-to-side to collectively form a square-shaped outer periphery, the end portions 136 fit into the sockets 124 formed in the side panels (the second side panels 130B in the illustrated example, but could be the first side panels 130A).

As shown in FIG. 5B, in some examples having multiple layers of intercoupled base modules 112, the module tree 134 is also at a center of the second layer 114B of intercoupled base modules 112. In such examples, the module tree 134 is configured to ensure the first four base modules 112 of the second layer 114B are properly positioned relative to each other by locking the base modules 112 to the module tree 134. By ensuring proper positioning between the first base modules 112 of the second layer 114B, proper positioning of all other base modules 112 of the second layer 114B, relative to each other and the base modules 112 of the first layer 114A, is ensured via the intercoupling of the base modules 112 of the second layer 114B. Accordingly, the second layer 114B is coupled with the first layer 114A via being in locking engagement with the module tree 134. In other words, in some examples, the base modules 112 of the first layer 114A are not directly interconnected with the base modules 112 of the second layer 114B. The module tree 134 of FIG. 5B is symmetrical and includes two sets 137A, 137B of four legs 135 where the legs 135 of each set are equally spaced apart and have the same length. Additionally, the two sets 137A, 137B of four legs 135 are vertically spaced apart from each other, to position the second layer 114B of base modules 112 vertically above the first layer 114A of base modules 112 by a predetermined distance. The legs 135 of each set of legs 135 are configured similarly (e.g., each one of the legs 135 extends from a central upright member 139 and includes an end portion 136 and a stop 138 spaced apart from the end portion 136).

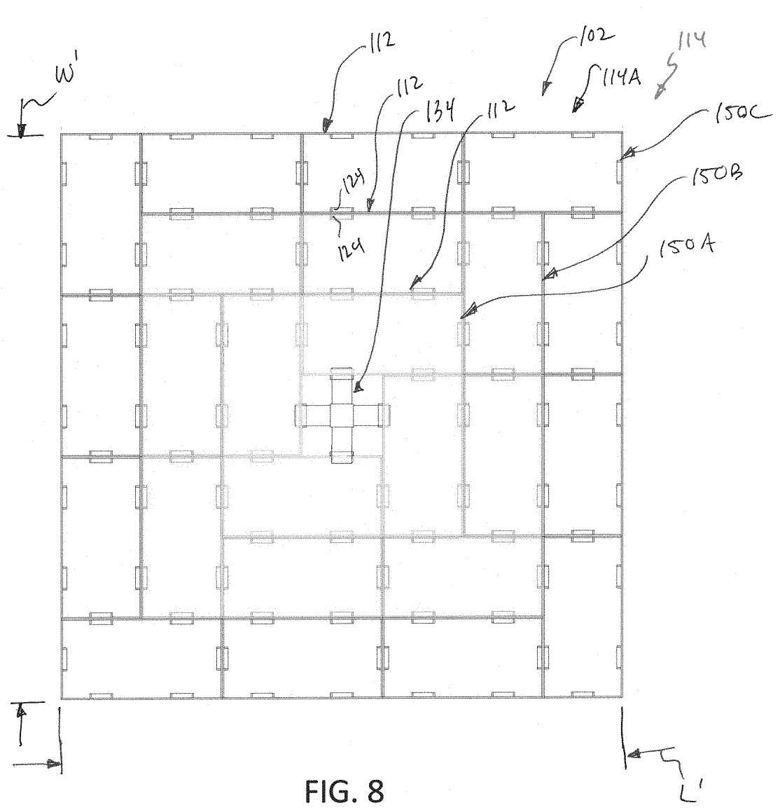

With the first four base modules 112 secured to the module tree 134 in this manner, a socket 124 formed in one of the side panels of each one of the base modules 112 is aligned with a socket 124 formed in one of the end panels of a corresponding one of an adjacent base module 112. As shown in FIG. 7, aligned sockets 124 are securely retained together by a corresponding one of a plurality of locking sleeves 140 of the base 102. The locking sleeves 140 are inserted into and engage with aligned sockets 124 via a sliding fit or push fit. The locking sleeves 140 are then maintained in place via a fastener, such as a screw or a clip. Engagement between a locking sleeve 140 and aligned sockets 124 is selectively reversible with access to the aligned sockets 124 from inside the base 102, but are otherwise are not reversible. The sockets 124 of the first four base modules 112 formed in an outer periphery of the first layer 114A (i.e., the sockets 124 formed in the panels that define the outermost extent of the periphery of the first layer 114A) are closed with a corresponding one of a plurality of locking caps 142. With access to the sockets 124 from inside the base 102, the locking caps 142 are fitted over an interior portion of the sockets 124 to effectively seal off the sockets 124 from outside the base 102. Like the locking sleeves 140, engagement between a locking cap 142 and a socket 124 is selectively reversible with access to the socket 124 from inside the base 102 but are otherwise are not reversible. In the example of FIG. 7, the outermost extent of the periphery of the first layer 114A are the panels of the first four base modules 112. However, in other examples, as shown in FIG. 8, the outermost extent of the periphery of the first layer 114A are the panels of additional base modules 112 added to the first four base modules 112.

Additional base modules 112 can be added to the first four base modules 112 to broaden the footprint of the first layer 114A of the module formation 114. Such broadening can facilitate an increase in the weight of the first layer 114A, for better anchoring the solar electronics platform 100, and/or facilitate additional battery or electronic functionality capacity. In one example shown in FIG. 8, eight additional base modules 112 are intercoupled with the first four base modules 112, and twelve additional base modules 112 are intercoupled with the additional eight base modules 112 for a total of twenty-four base modules 112 forming the first layer 114A. Intercoupling of the additional base modules 112 is accomplished in the same manner as the intercoupling of the first four bae modules 112 (e.g., via engagement between a plurality of aligned sockets 124 and locking sleeves 140. Although the first layer 114A in FIG. 8 has twenty-four base modules 112, as discussed, the first layer 114A can have more or less than twenty-four base modules in other examples. The width W′ of the base 102 is equal to the combined lengths L and width W of the base modules 112 forming one side of the base 102. Similarly, the length L′ of the base 102 is equal to the combined lengths L and width W of the base modules 112 forming a side of the base 102 that is perpendicular to the side forming the width W′.

After the first layer 114A of the module formation 114 is formed, a second layer, such as the second layer 114B, can be formed on, intercoupled with, and supported by the first layer 114A. In some examples, the second layer 114B has the same number of base modules 112 as the first layer 114A. However, in other examples, the second layer 114B has fewer base modules 112 than the first layer 114A. Any number of additional layers (e.g., up to Nth layer 114N) of base modules 112 can be added vertically onto an existing layer of base modules 112. The height of the base 102 is equal to the combined heights of layers of the base modules 112 (where the height of each layer is equal to a height of a base module 112 of that layer).

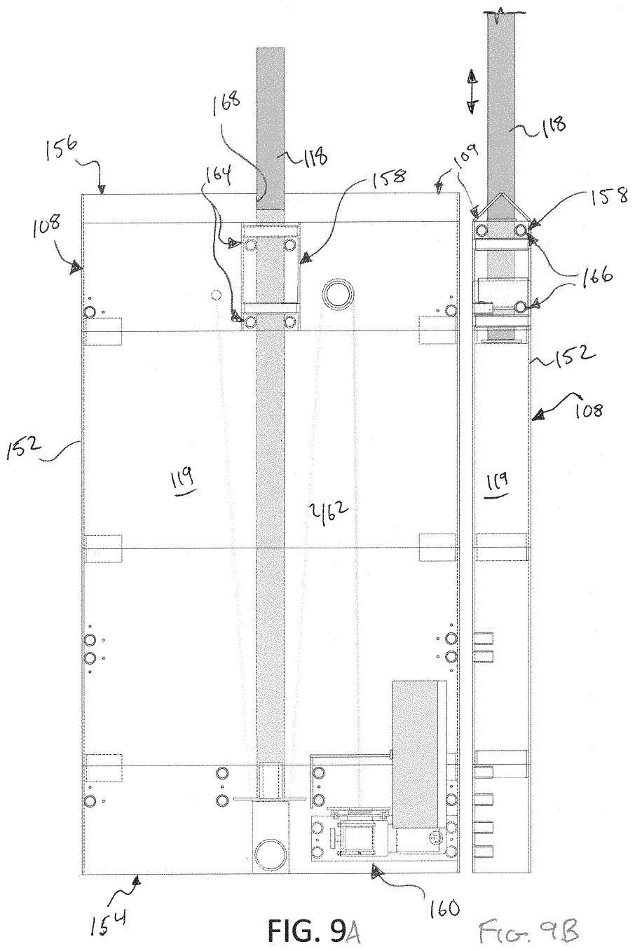

The mast carrier 108 forms part of or is attached to the housing 107 of the body 106. Referring to FIG. 9, the mast carrier 108 includes a housing 109 defined by vertical walls 152 that extend from a lower end 154 of the housing 109 to an upper end 156 of the housing 109. The housing 109 defines an interior cavity 119 that encloses a canopy deployment system 160 and at least a portion of the neck 118. The canopy deployment system 160 is coupled to the neck 118 and is operable to extend the neck 118 out of the interior cavity 119 through an opening 168 in the upper end 156 of the housing 109, to deploy or raise the canopy 116 into the raised position, and retract the neck 118 back into the interior cavity 119 via the opening 168, to retract or lower the canopy 116 into the lowered position. In one example, the canopy deployment system 160 includes a motor, cable, and pulley assembly that unwinds a cable 162 to lower the neck 118 and the canopy 116 and winds the cable 162 to raise the neck 118 and the canopy 116.

The mast carrier 108 additionally includes a neck alignment assembly 158 that ensures linear vertical movement of the neck 118 relative to the housing 109. The neck alignment assembly 158 includes first sets of rollers 164 spaced apart from each other in the vertical direction. The rollers of the first sets of rollers 164 prevent movement of the neck 118 in a first lateral direction while allowing linear translational movement of the neck 118 in the vertical direction. The neck alignment assembly 158 additionally includes second sets of rollers 166 spaced apart from each other in the vertical direction. The rollers of the second sets of rollers 166 prevent movement of the neck 118 in a second lateral direction, opposite the first lateral direction, while allowing linear translational movement of the neck 118 in the vertical direction. In some examples, the neck alignment assembly 158 further includes a clamping plate, or other comparable device, that is operable to selectively lock the neck 118 in the raised position.

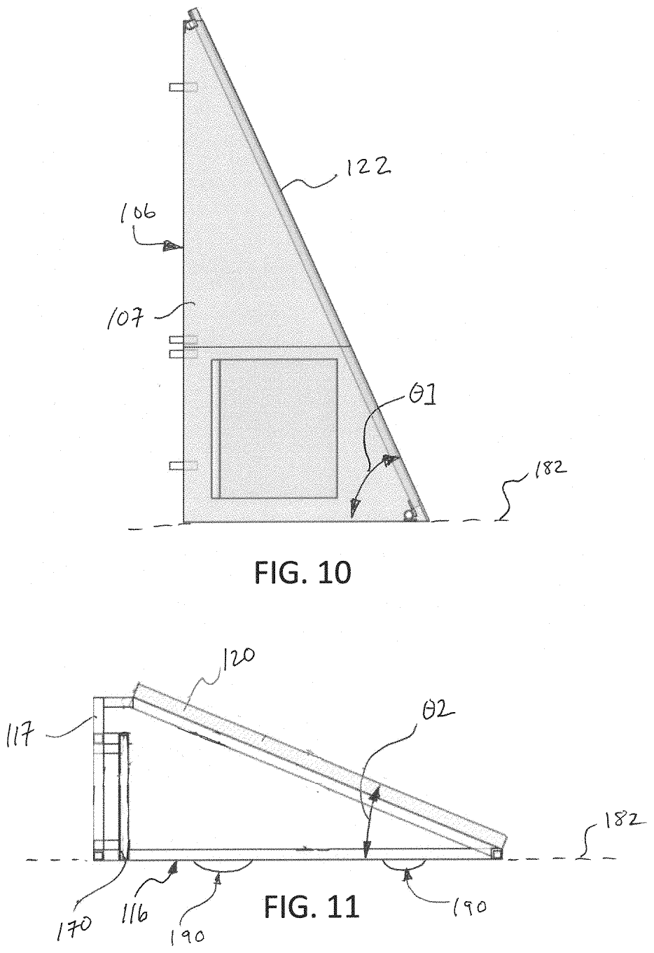

Referring to FIG. 10, the housing 107 of the body 106 supports the second solar panel 122 at a first angle θ1 relative to a horizontal plane 182. Correspondingly, in FIG. 11, the housing 117 of the canopy 116 supports the first solar panel 120 at a second angle θ2 relative to the horizontal plane 182. In some examples, where the ground surface 180 is level, the horizontal plane 182 is parallel to the ground surface 180. The first angle θ1 is greater than the second angle θ2. In certain examples, the first angle θ1 is selected to correspond with a nominal angle of the sun during late spring, summer, and early fall seasons, and the second angle θ2 is selected to correspond with a nominal angle of the sun during late fall, winter, and early spring seasons. In this manner, solar energy capture by the solar electronics platform 100 is optimized throughout the year by accommodating for seasonal changes in the solar angle.

The base modules 112, the housing 107 of the base 102, the neck 118, the housing 117 of the canopy 116, and any exterior structural components of the solar electronics platform 100 are made from armor-grade material, such as ¼-inch aluminum plates.

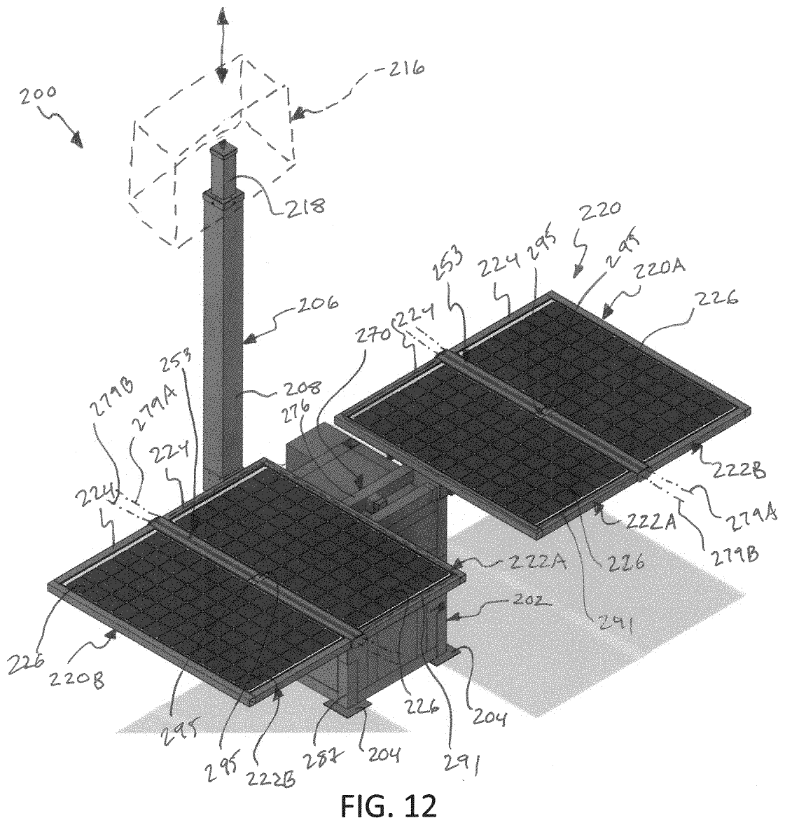

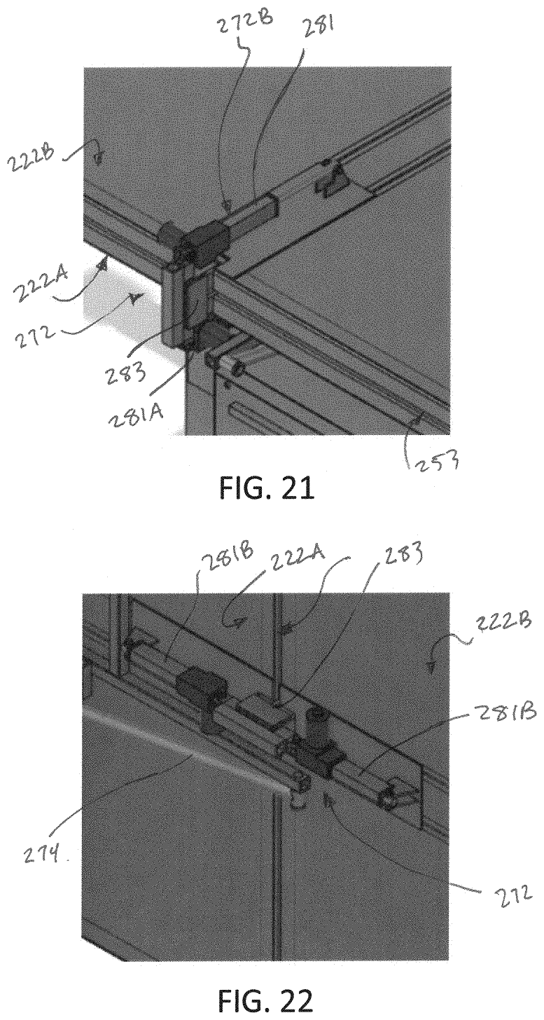

Referring to FIGS. 12-27, according to other examples of the present disclosure, a solar electronics platform 200 is shown. The solar electronics platform 200 provides features and enables advantages similar to those of the solar electronics platform 100. However, the solar electronics platform 200 also includes additional features that provide alternative advantages compared to those offered by the solar electronics platform 100.

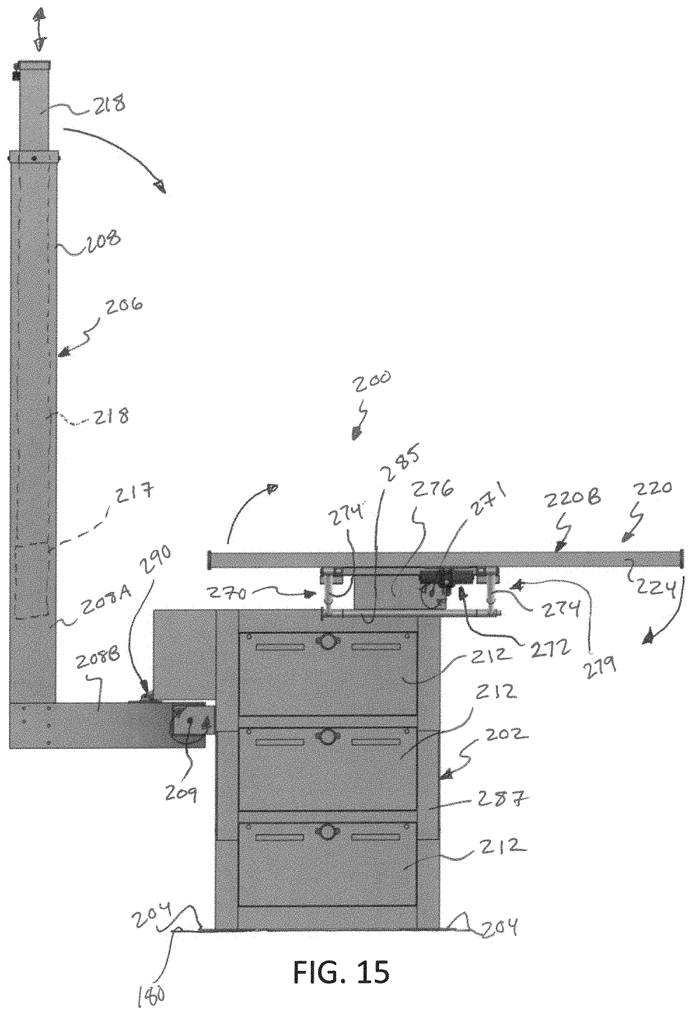

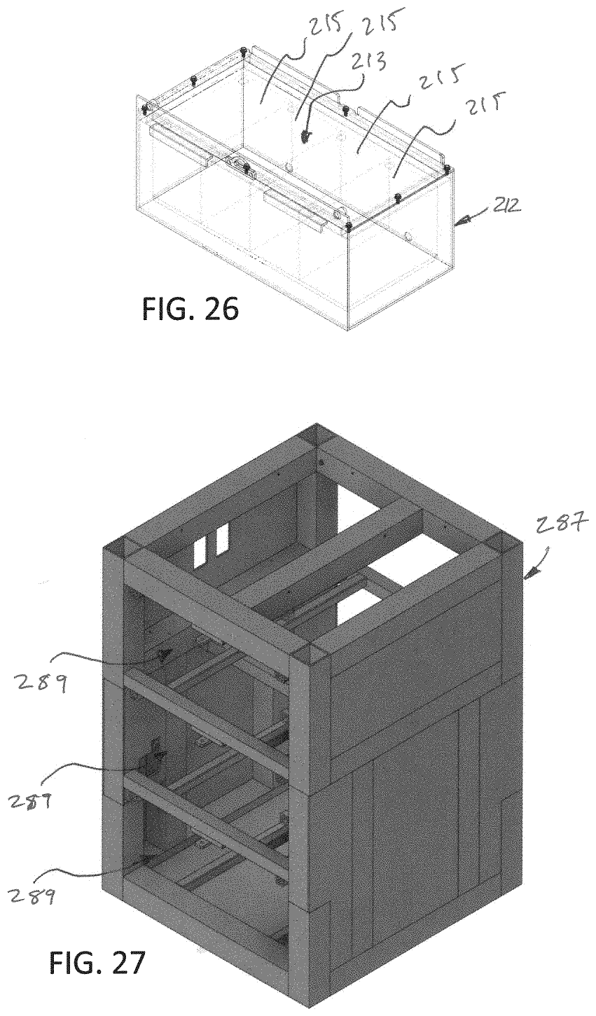

The solar electronics platform 200 includes a base 202 and a body 206. The body 206 is supported directly or indirectly on the base 202. At least a portion of the body 206 extends vertically above the base 202. Accordingly, at least a portion of the body 206 is vertically above the base 202. The base 102 includes a housing 287 and a plurality of base modules 212 coupled to the housing 287 (see, e.g., FIGS. 15, 17-20, 23, 26, and 27). The housing 287 provides a strong and secure framework for receiving and retaining the base modules 212 and other components of the solar electronics platform 200. As shown in FIG. 27, the housing 287 includes receptacles 289 each configured to receive and retain a corresponding one of the base modules 212, which are configured to be slidably inserted into the receptacles 289. Once inserted, the base modules 212 can be locked into place to prevent tampering of the base modules 212 and the interior of the base 202. Referring to FIG. 26, the base module 212 includes an interior cavity 213 that is configured to housing any of various components configured to provide functionality to the solar electronics platform 200. In the illustrated example, the base module 212 includes an array of batteries 215, which can be rechargeable batteries, that are configured to provide electrical power for the various electrical components of the solar electronics platform 200 and receive electrical power from the solar panels of the solar panel system 220. In certain examples, at least one of the base modules 212 includes rechargeable batteries 215 and at least one of the base modules 212 includes other electrical components. According to some examples, several of the base modules 212 includes rechargeable batteries 215.

The base 202 further includes a plurality of legs 204 coupled to the housing 287 and that support the housing 287 and base modules 212 on a support surface, such as a ground surface 180. The plurality of legs 204 are extendable and retractable, relative to the housing 287, to adjust a position or orientation of the base 202, and thus the body 206 supported on the base 202, relative to the ground surface 180. Accordingly, the plurality of legs 204 can be operable to level the base 202 and the body 206 on an otherwise non-level ground surface. Additionally, the plurality of legs 204 can be operable to raise the housing 287 for attachment of wheels or axels to the housing 287.

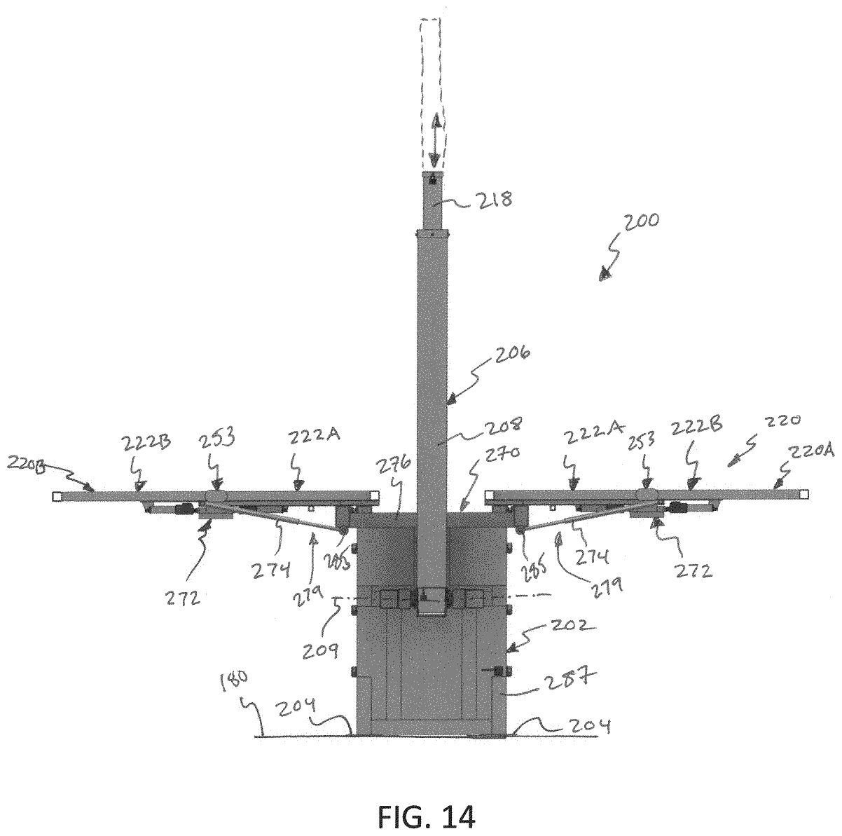

The body 206 includes a mast carrier 208 and, optionally, a head portion 216 that is movably coupled with the mast carrier 208 such that the head portion 216 can move relative to the mast carrier 208. The head portion 216 is movably coupled with the mast carrier 208 via a neck 218, or mast, that retracts into and extends out from the mast carrier 208. Accordingly, as indicated by directional arrows in FIGS. 12-15, the neck 218, and the head portion 216 supported on the neck 218, are raisable above the mast carrier 208, and thus the base 202, into a raised position (see, e.g., dashed lines of FIG. 14) and lowerable towards the mast carrier 208, and thus the base 202, into a lowered position (see, e.g., FIG. 12). The head portion 216 can include one or more security modules, such as one or more of the security modules 190 of the solar electronics platform 100 as described above. In certain examples, the security modules can be retractable to facilitate retraction of the security modules up into a housing of the head portion 216.

Referring to FIG. 15, the mast carrier 208 includes a housing that encloses a head-portion deployment system 217 and at least a portion of the neck 218. The head-portion deployment system 217 is engaged with the neck 218 and is operable to extend the neck 218 out of the housing of the mast carrier 208, to deploy or raise the head portion 216 into the raised position, and retract the neck 218 back into the housing of the mast carrier 208, to retract or lower the head portion 216 into the lowered position. In one example, the head-portion deployment system 217 includes a motor, cable, and pulley assembly that unwinds a cable to lower the neck 218 and the head portion 216 and winds the cable to raise the neck 218 and the head portion 216. In some examples, the mast carrier 208 includes a neck-containment portion 208A (or mast-containment portion) and a base-extension portion 208B. The neck-containment portion 208A is angled (e.g., at ninety degrees) relative to the base-extension portion 208B, which couples the neck-containment portion 208A to the base 202. In some examples, the head-portion deployment system 217 is at least partially located in the base-extension portion 208B of the mast carrier 208. Although not shown, the mast carrier 208 can additionally include a neck alignment assembly, similar to the neck alignment assembly 158 of the solar electronics platform 100, to ensure linear movement of the neck 218 relative to the neck-containment portion 208A.

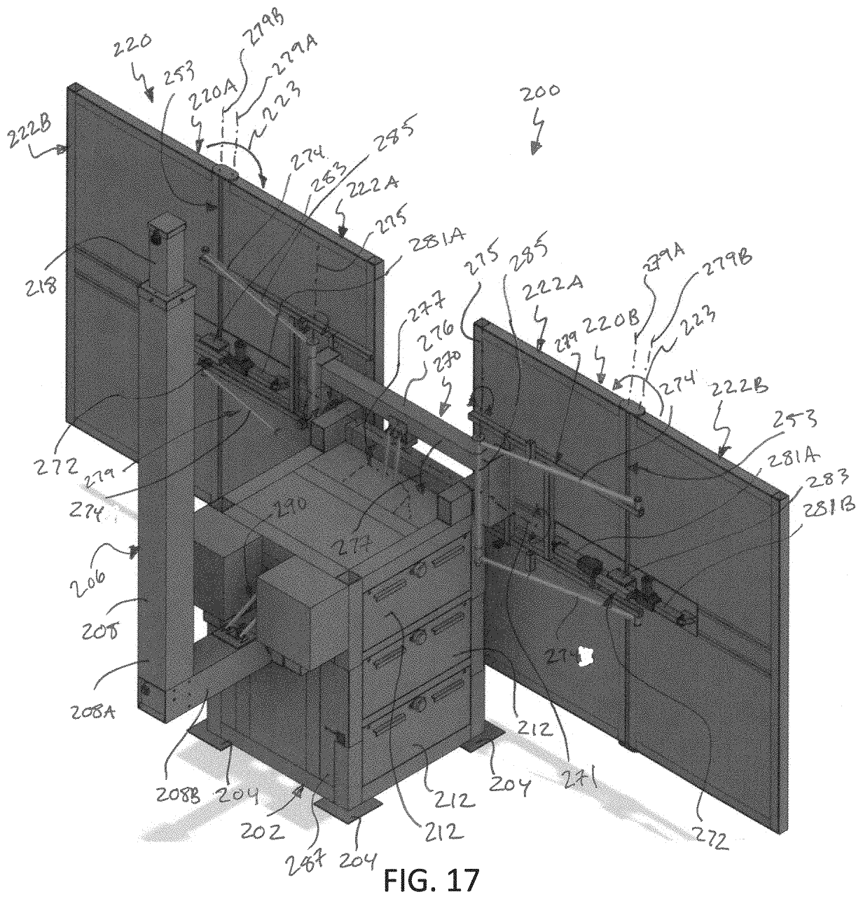

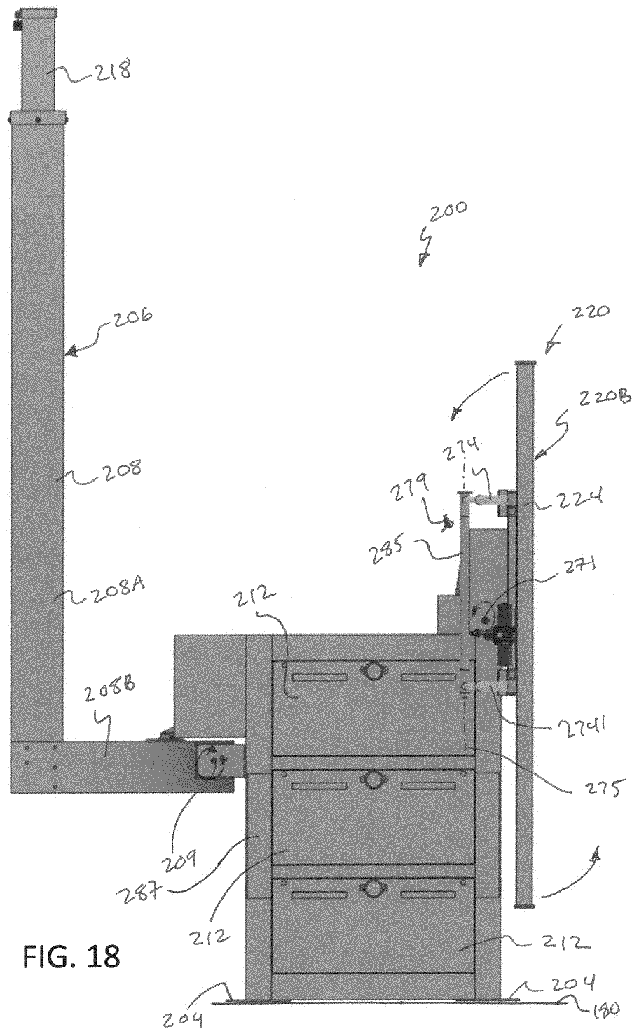

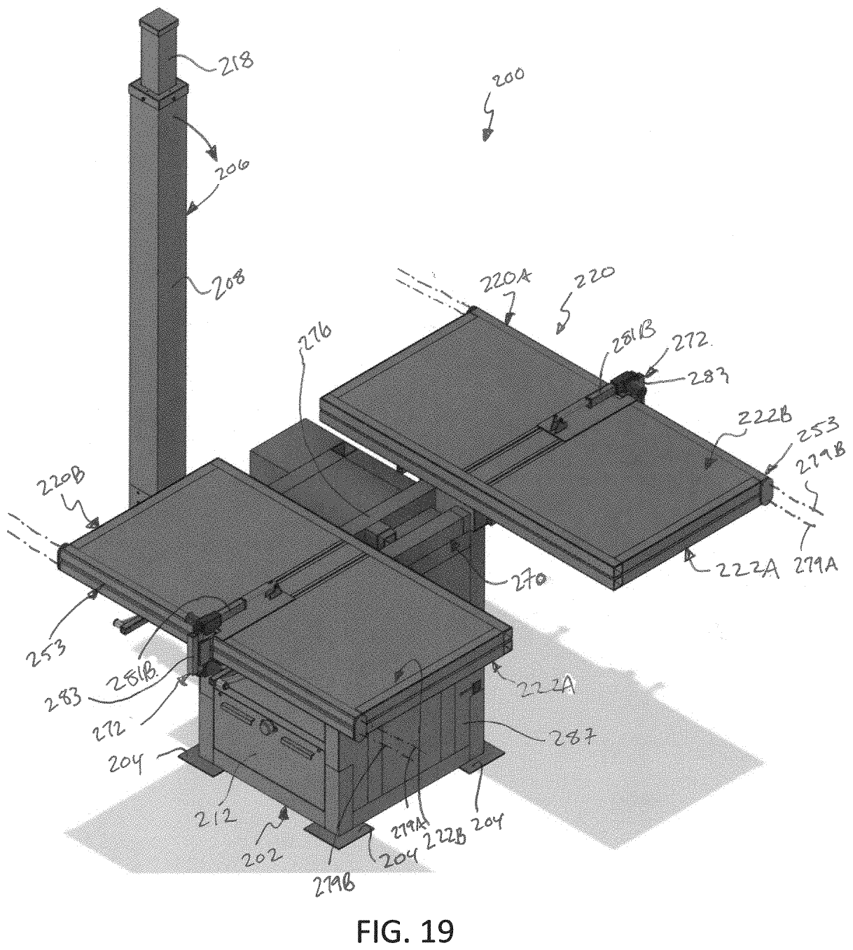

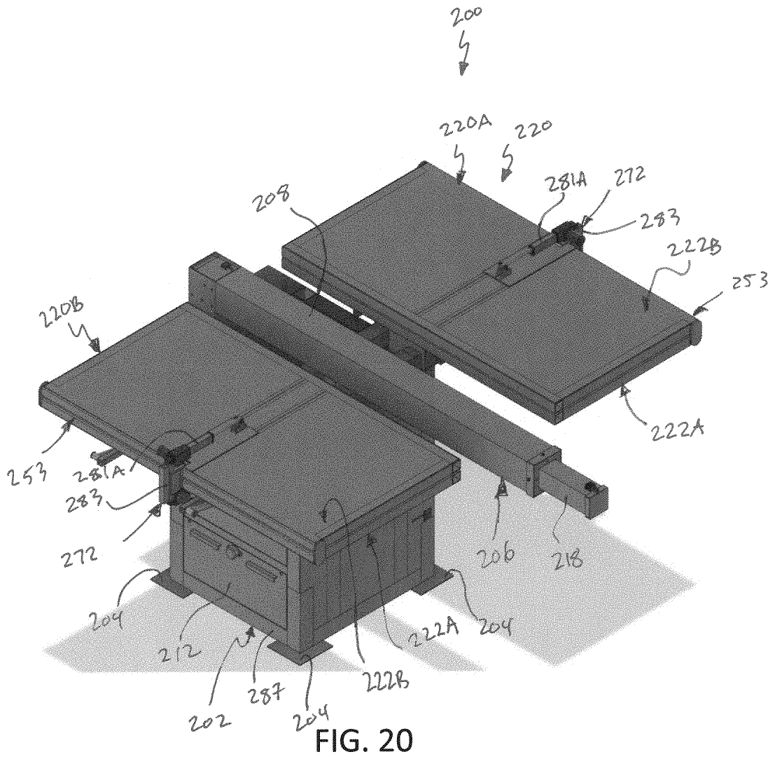

In some examples, the body 206 is movably coupled to the base 202. In some examples, the body 206 is movably coupled to the base 202 such that the body 206 can be selectively rotated or tilted relative to the base 202. As shown in FIGS. 15 and 17, the body 206 is pivotably coupled to the base 202 via a pivot-enabling connection 290, which, in the illustrated examples, includes a pivot pin, defining a pivot axis 209, about which the body 206 is allowed to pivot. Accordingly, from a vertical orientation (e.g., extended orientation) of the body 206, such as shown in FIG. 19, the body 206 can be tilted downwardly, as shown by a directional arrow, about the pivot axis 209 into a horizontal orientation (e.g., retracted orientation), as shown in FIG. 20. When the body 206 is in the vertical orientation, the head portion 216 can be positioned to provide security functionality. Then, when security functionality is not required or suspended, such as due to inactivity or environmental conditions, the body 206 can be pivoted into the horizontal orientation. Of course, when security functionality is needed, the body 206 can be pivoted from the horizontal orientation to the vertical orientation. The pivot-enabling connection 290 can include one or more actuators or motors that enable automated movement of the body 206 relative to the base 202. Referring to FIGS. 18-20, the neck-containment portion 208A and the base-extension portion 208B, being angled relative to each other, allows the body 206 to be compactly stored against the base 202 when the body 206 is in the horizontal orientation.

The solar electronics platform 200 additionally includes a solar panel system 220 that is coupled to the base 202 and is articulatable relative to the base 202. The solar panel system 220 includes a first solar-panel assembly 220A coupled to a first side of the base 202 and a second solar-panel assembly 220B coupled a second side of the base 202, which is opposite the first side of the base 202. The first solar-panel assembly 220A has the same features as the second solar-panel assembly 220B. Accordingly, the first solar-panel assembly 220A and the second solar-panel assembly 220B can be considered as mirror images of each other across a central plane of the base 202. Correspondingly, unless otherwise noted, features of the first solar-panel assembly 220A are equally applicable to the second solar-panel assembly 220B. Accordingly, a detailed description of the features of the first solar-panel assembly 220A follows.

The first solar-panel assembly 220A includes a first solar panel 222A and a second solar panel 222B. The first solar panel 222A is positioned closer to the base 202 than the second solar panel 222B when the first solar-panel assembly 220A is deployed (see, e.g., FIG. 12). Accordingly, the first solar panel 222A is considered an inner solar panel and the second solar panel 222B is considered an outer solar panel. Each one of the first solar panel 222A and the second solar panel 222B includes a frame 224 that rigidly supports and retains a plurality of solar cells 226. The solar cells 226 facilitate the conversion of solar energy from the sun to electrical energy, which can be stored in the battery 215 or batteries 215 of at least one of the base modules 212.

The first solar panel 222A and the second solar panel 222B can have any of various shapes. However, in the illustrated examples, each one of the first solar panel 222A and the second solar panel 222B has a polygonal shape, such as rectangular or square. The first solar panel 222A is pivotally coupled to the second solar panel 222B along a hinge 253. The hinge 253 enables pivoting of the second solar panel 222B away from the first solar panel 222A, along the hinge 253, to unfold (e.g., open) and to fold (e.g., close) the first solar-panel assembly 220A in a clamshell fashion. Accordingly, the is actuatable into an unfolded configuration (e.g., deployed or open configuration), as shown in FIGS. 12-18 and 22, and into a folded configuration (e.g., storage or closed configuration), as shown in FIGS. 19-21, 24, and 25.

In the unfolded configuration, the solar cells 226 of the first solar panel 222A and the second solar panel 222B are exposed to the sun and capable of absorbing solar energy from the sun. However, the solar cells 226 are also exposed to potentially harsh environmental conditions, such as wind, rain, hail, sandstorms, and the like, when the first solar-panel assembly 220A is in the unfolded configuration. Accordingly, under some circumstances, such as those caused by potential damage from environmental conditions, night or dark conditions, or when capturing solar energy is not needed, not feasible, or not available, the first solar panel 222A and the second solar panel 222B can be pivoted toward each other into the folded configuration, where the first solar panel 222A and the second solar panel 222B are flat against each other. To further aid in protecting the solar cells 226 from damage due to environmental conditions, at least one of the first solar panel 222A and the second solar panel 222B has a gasket 291 or seal positioned about a periphery of the corresponding frame 224. In the folded configuration, the gasket 291 forms a seal between the frames 224 of the first solar panel 222A and the second solar panel 222B to prevent foreign objects or debris from entering in between the first solar panel 222A and the second solar panel 222B.

According to one example, the hinge 253 of the first solar-panel assembly 220A enables pivoting about a first panel axis 279A and a second panel axis 279B, which are spaced apart and parallel to each other and are both considered a panel axis of rotation. Such a dual-axis hinge enables the first solar panel 222A and the second solar panel 222B to be located side-by-side and co-planar relative to each other, when in the unfolded orientation, and parallel to each other, when in the folded orientation. The first panel axis 279A and the second panel axis 279B are defined by corresponding tubes 295 passing through corresponding ones of adjoined portions of the frames 224. The tubes 295 are allowed to rotate within the frames 224, such that the frames 224 can rotate about the corresponding tubes 295. A section of the adjoined portions of the frames 224 is removed to expose the tubes 295. The exposed portions of the tubes 295 of each one of the first solar-panel assembly 220A and the second solar-panel assembly 220B are retained by a bracket 283, which is a U-shaped bracket in some examples.

Referring to FIGS. 17 and 22, the first solar-panel assembly 220A further includes a panel actuation system 272 that includes the bracket 283. The panel actuation system 272 additionally includes a pair of actuators (e.g., a first-panel actuator 281A and a second-panel actuator 381B) fixed relative to the bracket 283. The first-panel actuator 281A and second-panel actuator 381B, which can be linear actuators, are also fixed relative to a corresponding one of the first solar panel 222A and the second solar panel 222B. When the first solar-panel assembly 220A is in the unfolded configuration, the first-panel actuator 281A and the second-panel actuator 281B are actuatable to lengthen the first-panel actuator 281A and the second-panel actuator 281B to pivot the bracket 283 about the first panel axis 279A and pivot the second solar panel 222B about the second panel axis 279B, in first rotational directions, which enables a smooth rotation of the second solar panel 222B relative to the first solar panel 222A and enables placement of the second solar panel 222B flat against the first solar panel 222A. When the first solar-panel assembly 220A is in the folded configuration, the first-panel actuator 281A and the second-panel actuator 281B are actuatable to shorten the first-panel actuator 281A and the second-panel actuator 281B to pivot the bracket 283 about the first panel axis 279A and pivot the second solar panel 222B about the second panel axis 279B, in second rotational directions opposite the first rotational direction, which enables a smooth rotation of the second solar panel 222B relative to the first solar panel 222A and enables placement of the second solar panel 222B co-planar with the first solar panel 222A.

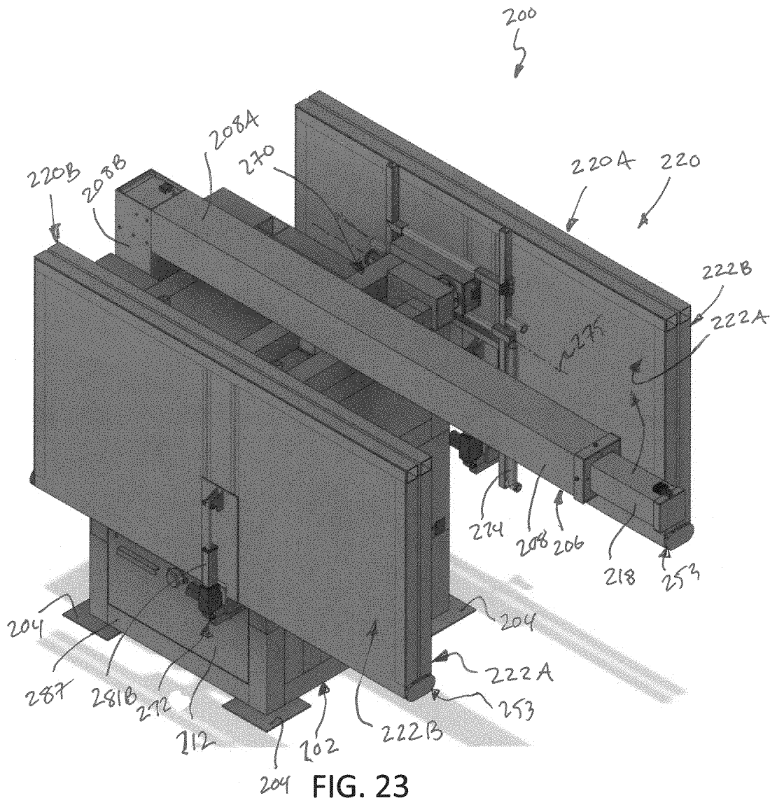

The solar panel system 220 further includes a forward tilt mechanism 270 coupled to the base 202 and to the first solar-panel assembly 220A and the second solar-panel assembly 220B. The forward tilt mechanism 270 is configured to tilt the first solar-panel assembly 220A and the second solar-panel assembly 220B about forward tilt axis 271 (see, e.g., FIGS. 17 and 18). The forward tilt axis 271, which is one of multiple base axes of rotation, is perpendicular to the first panel axis 279A and the second panel axis 279B. The forward tilt mechanism 270 enables the first solar panel 222A and the second solar panel 222B of the first solar-panel assembly 220A and the second solar-panel assembly 220B to face any of various angles relative to the ground surface 180 when unfolded. Accordingly, the first solar panel 222A and the second solar panel 222B can be tilted to face an angle, relative to the sun, that promotes the most efficient absorption of solar energy by the first solar panel 222A and the second solar panel 222B. Additionally, the forward tilt mechanism 270 facilitates placement of the first solar panel 222A and the second solar panel 222B in a proper orientation to configure the solar electronics platform 200 into a non-use configuration, as is shown in FIGS. 23 and 25.

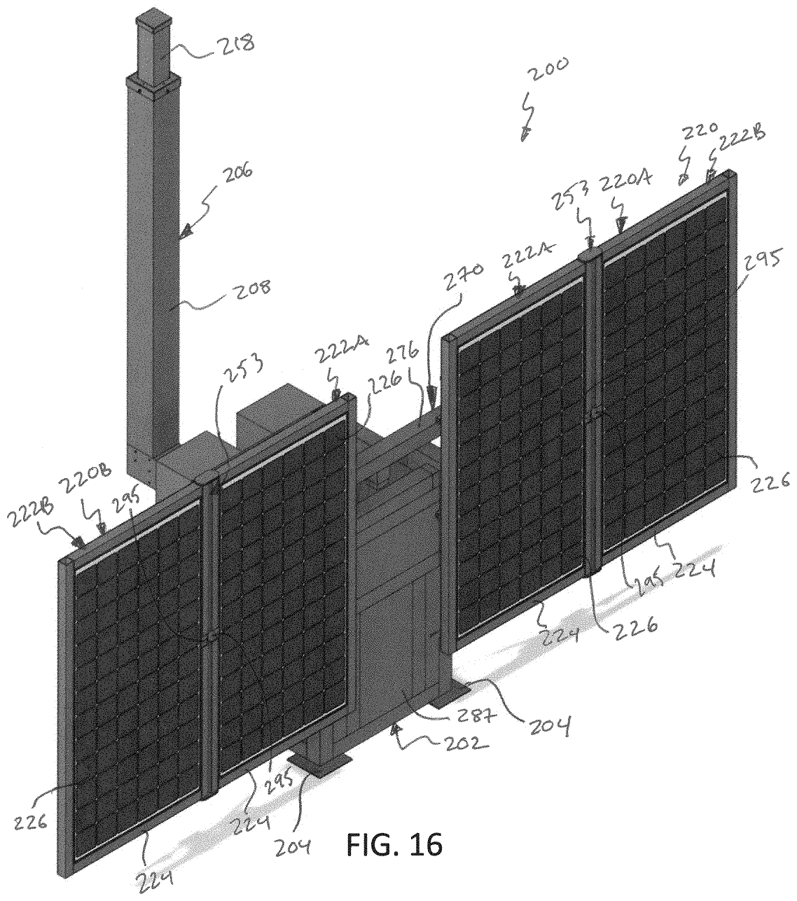

The forward tilt mechanism 270 includes a swivel bracket 276 that is pivotably coupled to the base 202. The swivel bracket 276 includes a mounting surface to which the first solar panels 222A are fixed and which is parallel with the broad-facing surface of the first solar panels 222A. The swivel bracket 276 can pivot relative to the base 202 such that the mounting surface of the swivel bracket 276 can be positioned parallel to the ground surface 180 and angled (e.g., 90 degrees) relative to the ground surface 180. In this manner, actuation of the swivel bracket 276 can move the first solar panels 222A (and thus the second solar panels 222B) into a horizontal configuration parallel with the ground surface 180 (see, e.g., FIG. 12) or a vertical configuration perpendicular with the ground surface 180 (see, e.g., FIG. 16). As shown in FIG. 17, automation of the swivel bracket 276 can be facilitated by an actuator 277, such as one or more linear actuators. To promote rotation of the swivel bracket 276 relative to the base 202, bearings can positioned between the swivel bracket 276 and base 202.

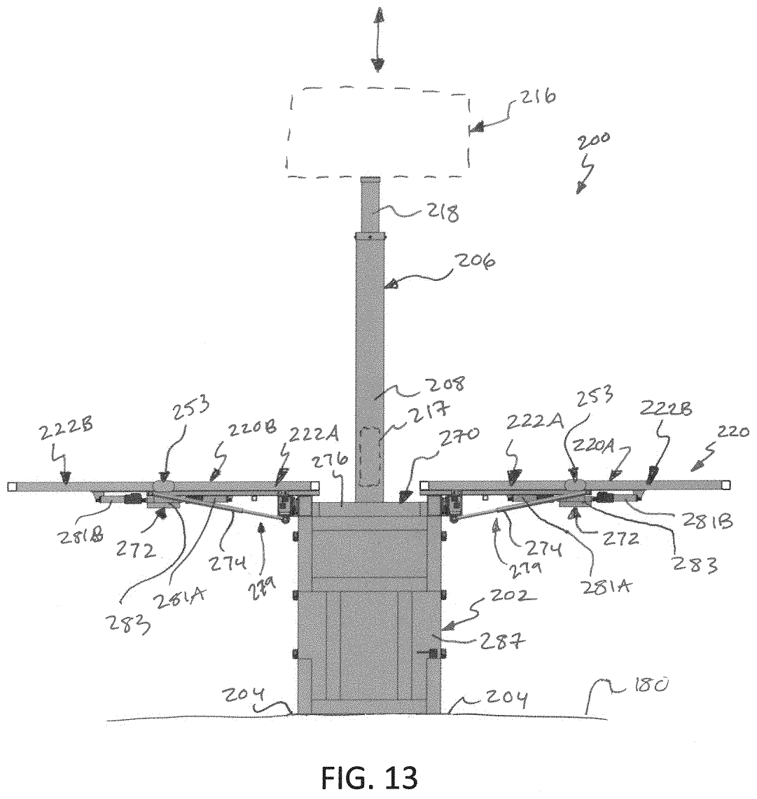

Referring to FIGS. 13-18, to provide further adjustability of the orientation of the first solar-panel assembly 220A and the second solar-panel assembly 220B, each one of the first solar-panel assembly 220A and the second solar-panel assembly 220B includes a lateral tilt mechanism 279. With reference to the first solar-panel assembly 220A, but equally applicable to the second solar-panel assembly 220B, the lateral tilt mechanism 279 includes a pivot joint 285 that defines a lateral tilt axis 275. The lateral tilt axis 275, which is one of multiple base axes of rotation, is parallel to the first panel axis 279A and the second panel axis 279B, and is perpendicular to the forward tilt axis 271. The pivot joint 285 is fixed to the swivel bracket 276 such that the pivot joint 285 co-moves with the swivel bracket 276. The lateral tilt mechanism 279 additionally includes at least one linear actuator 274. In the illustrated example, the lateral tilt mechanism 279 includes two linear actuators 274. A first end of each one of the linear actuators 274 is fixed, with a rotatable fit, to the pivot joint 285 and the second end of each one of the linear actuators 274 is fixed, with a rotatable fit, to the first solar panel 222A of the first solar-panel assembly 220A. As the linear actuators 274 actuate to increase and decrease a length of the linear actuators 274 (e.g., increase and decrease a distance between the first and second ends of the linear actuators 274), the first solar-panel assembly 220A rotates relative to the base 202 to bring the second solar panel 222B respectively away from and closer to the base 202.

As presented above, the solar electronics platform 200 is configurable into multiple configurations by adjusting the position of one or more of the body 206 or the solar panel system 220. When the solar electronics platform 200 is not in use, is in storage, or is being transported, the solar electronics platform 200 can be placed in a non-use configuration. As shown in FIGS. 23-25, in the non-use configuration, the body 206 is retracted such that neck-containment portion 208A of the mast carrier 208 is horizontally oriented in close proximity to the base 202 (e.g., parallel to the ground surface 180). Additionally, the neck-containment portion 208A is located directly between the first solar-panel assembly 220A and the second solar-panel assembly 220B. More specifically, the neck-containment portion 208A can be positioned in a gap defined between the first solar-panel assembly 220A and the second solar-panel assembly 220B. Also, in the non-use configuration, the first solar-panel assembly 220A and the second solar-panel assembly 220B are in the folded configuration and vertically oriented in close proximity to the base 202 (e.g., perpendicular to the ground surface 180), such that the hinge 253 is parallel to the ground surface 180. Such a configuration streamlines the solar electronics platform 200 and promotes a reduced footprint. However, in some examples, in the non-use configuration, the first solar-panel assembly 220A and the second solar-panel assembly 220B are in the folded configuration and horizontally oriented (e.g., parallel to the ground surface 180), such as shown in FIG. 19.

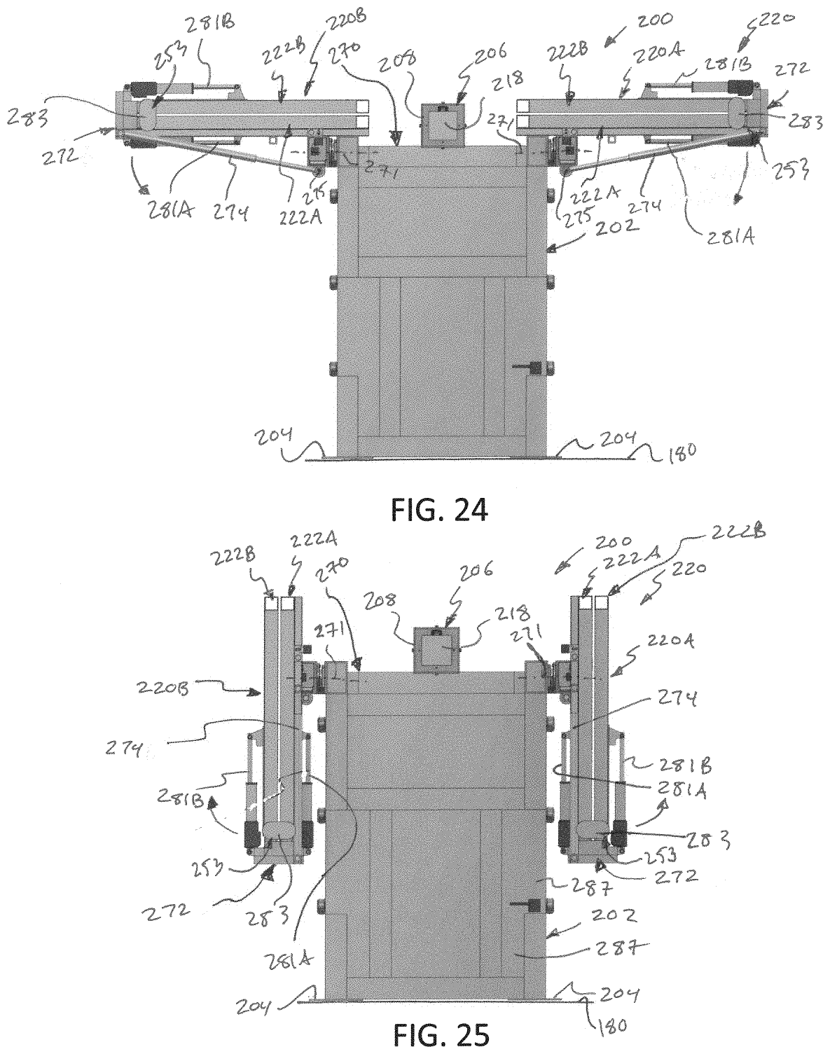

As shown in FIG. 19, the solar electronics platform 200 can be placed in a non-regenerating, in-use configuration where the first solar-panel assembly 220A and the second solar-panel assembly 220B are in the folded configuration, but the body 206 is extended such that neck-containment portion 208A of the mast carrier 208 is vertically oriented relative to the base 202 (e.g., perpendicular to the ground surface 180). In this configuration, the security module(s) of the head portion 216 are actively providing security functionality while the first solar-panel assembly 220A and the second solar-panel assembly 220B are closed and not collecting solar energy. Additionally, the neck 218 can be extended from the mast carrier 208 to position a head portion 216 on the neck 218 higher relative to the ground surface 180. In the non-regenerating, in-use configuration, the unfolded first solar-panel assembly 220A and the second solar-panel assembly 220B can be vertically oriented, as in FIGS. 23 and 25 or horizontally oriented, as in FIGS. 19 and 24.

Finally, as shown in FIGS. 12-18, the solar electronics platform 200 can be placed in a regenerating, in-use configuration where the first solar-panel assembly 220A and the second solar-panel assembly 220B are in the unfolded configuration, and the body 206 is extended such that neck-containment portion 208A of the mast carrier 208 is vertically oriented relative to the base 202. In this configuration, the security module(s) of the head portion 216 can be actively providing security functionality while the first solar-panel assembly 220A and the second solar-panel assembly 220B are collecting solar energy. As presented above, when in the unfolded configuration, the first solar-panel assembly 220A and the second solar-panel assembly 220B can be forwardly and rearwardly tilted at any of various angles relative to the ground surface 180 (e.g., parallel, as shown in FIGS. 12-15, perpendicular, as shown in FIGS. 16-18, or any of various angles in between). When the first solar-panel assembly 220A and the second solar-panel assembly 220B are parallel to the ground surface 180, an entirety of the solar panels are above the base 202, such that an entirety of the base 202 is between the solar panels and the ground surface 180. When in the first solar-panel assembly 220A and the second solar-panel assembly 220B are perpendicular to the ground surface 180, at least a portion of the solar panels are below the base 202, such that at least the portion of the solar panels are closer to the ground surface 180 than a top of the base 202.

Actuation of the movable components of the solar electronics platform 200, for transitioning between the various configurations of the solar electronics platform 200, are accomplished in a particular order in some examples. In one example, the first solar-panel assembly 220A and the second solar-panel assembly 220B are not lowered into the vertical orientation shown in FIG. 23 until after the first solar-panel assembly 220A and the second solar-panel assembly 220B are placed in the folded configuration. Similarly, the first solar-panel assembly 220A and the second solar-panel assembly 220B are not raised into the horizontal orientation, such as shown in FIGS. 12 and 24, unless the first solar-panel assembly 220A and the second solar-panel assembly 220B are in the folded configuration.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A solar electronics platform, comprising:
a base, comprising a plurality of base modules;
a body, movably coupled to the base such that the body is pivotable, relative to the base, between a vertical orientation and a horizontal orientation, inclusive, and comprising a head portion, having one or more security modules, and a mast carrier, configured to raise and lower the head portion relative to the base when the body is in the vertical orientation; and
a solar panel system, movably coupled to the base such that the solar panel system is pivotable, relative to the base, about at least one base axis of rotation.

2. The solar electronics platform according to claim 1, wherein the solar panel system is pivotable, relative to the base, about at least two base axes of rotation.

3. The solar electronics platform according to claim 2, wherein the at least two base axes of rotation are perpendicular relative to each other.

4. The solar electronics platform according to claim 2, wherein, when the base is supported on a ground surface, one of the at least two base axes of rotation is perpendicular to the ground surface and another one of the at least two base axes of rotation is parallel to the ground surface.

5. The solar electronics platform according to claim 1, wherein the solar panel system comprises a solar-panel assembly that comprises a first solar panel and a second solar panel pivotably coupled together along a hinge.

6. The solar electronics platform according to claim 5, wherein the first solar panel and the second solar panel are pivotable relative to each other about the hinge between a folded configuration, in which the first solar panel and the second solar panel are parallel to each other and laid flat against each other, and an unfolded configuration, in which the first solar panel and the second solar panel are side-by-side and co-planar.

7. The solar electronics platform according to claim 6, wherein:
the hinge defines two panel axes of rotation;
the first solar panel and the second solar panel are pivotable about the two panel axes of rotation; and
the two panel axes of rotation are parallel and spaced apart from each other.

8. The solar electronics platform according to claim 7, wherein the two panel axes of rotation are either parallel to or perpendicular to the at least one base axes of rotation.

9. The solar electronics platform according to claim 6, wherein the solar panel system comprises two solar-panel assemblies each coupled to a corresponding one of two opposite sides of the base.

10. The solar electronics platform according to claim 9, wherein:
the two solar-panel assemblies are spaced apart from each other, such that a gap is defined between the two solar-panel assemblies; and
at least a portion of the body is located in the gap when the body is in the horizontal orientation.

11. The solar electronics platform according to claim 9, wherein:
the solar panel system is pivotable, relative to the base, about at least two base axes of rotation;
the two solar-panel assemblies are co-planar or parallel to each other as the solar panel system pivots about a first one of the at least two base axes of rotation; and
the two solar-panel assemblies transition from being co-planar or parallel to each other to being angled relative to each other as the solar panel system pivots about second ones of the at least two base axes of rotation.

12. The solar electronics platform according to claim 6, wherein:
the solar-panel assembly further comprises a gasket fixed to at least one of the first solar panel and the second solar panel; and
when in the folded configuration, the gasket forms a seal between the first solar panel and the second solar panel.

13. The solar electronics platform according to claim 1, wherein:
the solar panel system comprises a solar-panel assembly comprising a solar panel; and
when the base is supported on a ground surface, the solar panel system is pivotable about the at least one base axis of rotation between a first orientation, in which the solar panel is parallel to the ground surface, a second orientation, in which the solar panel defines an acute angle relative to the ground surface, and a third orientation, in which the solar panel is perpendicular to the ground surface.

14. The solar electronics platform according to claim 13, wherein:
when in the first orientation, an entirety of the solar panel is above the base, such that an entirety of the base is between the solar panel and the ground surface; and
when in the third orientation, at least a portion of the solar panel is below the base, such that at least the portion of the solar panel is closer to the ground surface than a top of the base.

15. The solar electronics platform according to claim 1, wherein the base further comprises a plurality of legs that are extendable and retractable relative to the plurality of base modules.

16. The solar electronics platform according to claim 1, wherein at least one of the plurality of base modules contains at least one battery that is electrically coupled with the solar panel system to receive electrical power from the solar panel system and electrically coupled with the head portion to provide power to the one or more security modules.

17. The solar electronics platform according to claim 1, wherein the solar panel system is pivotable, relative to the base, about at least three base axes of rotation.

18. The solar electronics platform according to claim 1, wherein:
the mast carrier comprises a base-extension portion and a mast-containment portion;
the mast-containment portion contains a mast of the body that supports the head portion and that is raisable and lowerable within the mast-containment portion;
the base-extension portion is angled relative to the mast-containment portion; and
the base-extension portion is pivotably coupled directly to the base and is located between the mast-containment portion and the base.

19. The solar electronics platform according to claim 1, wherein the solar panel system comprises:
a first solar panel fixed to the head portion at a first angle relative to a horizontal plane; and
a second solar panel fixed to the body at a second angle relative to the horizontal plane, wherein the first angle is less than the second angle.

20. The solar electronics platform according to claim 1, wherein adjacent ones of the plurality of base modules are interlocked together via alignment between sockets of the adjacent ones of the plurality of base modules and locking sleeves engaged with the sockets.
